(19) United States
(12) Patent Application Publication
(10) Pub. No.: US 2004/0039735 A1
(43) Pub. Date: Feb. 26, 2004

(54) Computer-implemented method and system for performing searching for products and services

(76) Inventors: Maria A. Ross, Bloomfield Township, MI (US); Robin L. Clinesmith, Livonia, MI (US); Eduardo Cancellara JR., Bahia (BR)

Correspondence Address: BROOKS KUSHMAN P.C./FGTL, 1000 TOWN CENTER, 22ND FLOOR, SOUTHFIELD, MI, 48075-1238, US

(21) Appl. No.: 10/464,376

(22) Filed: Jun. 18, 2003

Related U.S. Application Data
(60) Provisional application No. 60/389,967, filed on Jun. 19, 2002.

(51) Int. Cl. G06F 7/00

(52) U.S. Cl. 707/3

(57) ABSTRACT

A computer-implemented method for performing searching for products and services is disclosed. The method includes receiving a commodity database, the commodity database including commodity records, each commodity record including supplier name, a commodity description, a commodity code and an inventory level for the commodity, receiving one or more search attributes, a purchasing strategy, and a manufacturing strategy, the purchasing strategy identifying one or more preferred suppliers based on the commodity code in each commodity record, the manufacturing strategy based on a target inventory level for a commodity described in at least one of the commodity records, and searching the commodity database to obtain one or more located commodity records that satisfy the one the one or more attributes, the purchasing strategy and the manufacturing strategy.

### CROSS-REFERENCE TO RELATED APPLICATION

This application claims the benefit of U.S. provisional application Serial No. 60/339,967, filed Jun. 19, 2002, and entitled “Parametric Search Engine”.

### BACKGROUND OF THE INVENTION

1. Field of the Invention

One of the aspects of the present invention relates to electronic procurement systems having a guided search engine for performing searching for products and services.

2. Background Art

A distributed enterprise is an organization having multiple operations spread across a geographic region, continent or globe. In today's business environment, thousands of businesses have operating facilities located in more than one country or continent. For example, an automobile manufacturer may have multiple management facilities, engineering facilities, manufacturing facilities, assembly facilities, distribution facilities, sales facilities and service facilities located within most countries and every continent on the planet. Each of these facilities must, in turn, deal with a second-tier of often equally-distributed supplier communities.

Distributed enterprises present a unique challenge to conventional electronic procurement management software. Most procurement systems are tailored to effectively meet the needs of smaller to mid-sized businesses having a few, if any, distributed business operations or supplier base. However, these conventional systems lack functionality to effectively support certain business needs of large to very large companies that are distributed across a wide geographical range.

For years, electronic data interchange (EDI) and virtual private network (VPN) technologies have enabled businesses and their suppliers to exchange invoices, purchase orders, and other documents to conduct their day-to-day business online. Typically, these systems were proprietary in nature, required a dedicated technical infrastructure, and required a costly subscription or pay-per-use access arrangement.

The advent of the Internet has revolutionized electronic procurement systems by decreasing the speed, cost and other hurdles associated with the first-generation systems. Without such access barriers, buyers are presented with a broader horizon of potential suppliers. Today, a buyer organization can access the Internet to obtain pricing information, product and service information, submit a purchase request, route the request for approval, view the fulfillment status of the request, receive a receipt and delivery notification, and transmit payment.

According to one IDC survey conducted in September 2000, the amount of savings generated with the use of an Internet-enabled procurement system will, on average, range from 5.0% to 8.5% of a company's purchasing budget. Depending on the size of the company, this savings can translate to over a billion dollars annually.

In the manufacturing industry, resource demand can be generalized into two broad categories: direct and indirect. Direct procurement includes the purchasing of resources that make up the product ultimately being manufactured. Indirect procurement includes the purchasing of “support” resources that are necessary to bring about the manufacture of the product. In an automobile manufacturing example, a direct resource might be the paint or windshield for a particular automobile. An indirect resource might include a day-to-day commodity such as wrenches or safety glasses that, although not technically a part of the automobile, are indirectly necessary to manufacture the automobile.

Today, companies such as General Electric and Compaq Computer have integrated electronic procurement systems to streamline the online sourcing and purchasing of direct and indirect materials. For example, Compaq Computer employees can use their Web browser to view an online supplier catalog of over 37,000 items, and easily purchase the resources necessary to satisfy their day-to-day needs. Companies such as Compaq can expand this functionality to increase the variety of resources available, rationalize its supply base, and consolidate its supply chain in an effort to leverage purchase volumes into fewer suppliers and improve its relationship with a preferred supply base.

One electronic procurement application is Oracle Procurement. A detailed description of the Oracle Procurement application can be found at www.oracle.com. Other developers of procurement solutions include Ariba (www.ariba.com), i2 (www.i2.com), CommerceOne (www.commerceone.com), SAP (www.sap.com) and PeopleSoft (www.peoplesoft.com).

Issued U.S. patents relating to electronic procurement applications and systems include U.S. Pat. No. 5,970,475 to Barnes et al. and U.S. Pat. No. 6,363,365 to Kou. Published U.S. patent applications relating to electronic procurement applications and systems include U.S. patent application Ser. No. 2001/0042050 to Fletcher et al. Additional information relating to electronic procurement systems includes Albert Pang's IDC White Paper eProcurement Ensures Visionary Companies a Place in the New Economy, July 2001.

As comprehensive and beneficial as today's procurement systems may be, there still remains a wide horizon for improvement. For example, there is a need to provide a search engine that enables procurement system users to search based on the user's profile setup.

### SUMMARY OF THE INVENTION

According to a first embodiment of the present invention, a computer-implemented method for performing searching for products and services is disclosed. The method includes receiving a commodity database, the commodity database including one or more commodity records, each commodity record including supplier name, a description for a commodity, a commodity code and an inventory level for the commodity, receiving one or more search attributes, a purchasing strategy, and a manufacturing strategy, the purchasing strategy identifying one or more preferred suppliers based on the commodity code in each commodity record, the manufacturing strategy based on a target inventory level for a commodity described in at least one of the commodity records, and searching the commodity database to obtain one or more located commodity records that satisfy the one the one or more attributes, the purchasing strategy and the manufacturing strategy, the one or more located commodity records being relied upon to requisition products and services.

The method can further include receiving a desired commodity record from the one or more located commodity records. The method can further include searching a blanket database to obtain one or more located commodity records that satisfy the one the one or more attributes, the purchasing strategy and the manufacturing strategy, the blanket database including one or more commodity records, each commodity record including supplier name and a description for a commodity. The method can further include receiving a desired commodity record from the one or more located commodity records from either the commodity database or the blanket database.

The method can further include transmitting the desired commodity record in an electronic form. The electronic form can be selected from the group consisting of a requisition, a shopping cart item and a request for quotation. The method can further include causing display of the one or more located commodity records. If no commodity records from the commodity database and the blanket database satisfy the one the one or more attributes, the purchasing strategy and the manufacturing strategy, then the method can receive a request to change the one or more search attributes. If no commodity records from the commodity database and the blanket database satisfy the one the one or more attributes, the purchasing strategy and the manufacturing strategy, then the method can receive a request to create a new requisition. The method can include creating a new requisition.

In certain embodiments, the one or more attributes can be provided by a requisitioner. The purchasing and manufacturing strategies can be provided by a buyer organization. The commodity database can be provided by the buyer organization.

According to a second embodiment of the present invention, a computer-implemented system for performing searching for products and services is disclosed. The system can comprise at least one server computer for communicating with at least one client computer. The at least one server computer can be configured to receive a commodity database, the commodity database including one or more commodity records, each commodity record including supplier name, a description for a commodity, a commodity code and an inventory level for the commodity, receive one or more search attributes, a purchasing strategy, and a manufacturing strategy, the purchasing strategy identifying one or more preferred suppliers based on the commodity code in each commodity record, the manufacturing strategy based on a target inventory level for a commodity described in at least one of the commodity records and search the commodity database to obtain one or more located commodity records that satisfy the one the one or more attributes, the purchasing strategy and the manufacturing strategy, the one or more located commodity records being relied upon to requisition products and services:

The system can be further configured to receive a desired commodity record from the one or more located commodity records. The at least one server computer can be further configured to search a blanket database to obtain one or more located commodity records that satisfy the one the one or more attributes, the purchasing strategy and the manufacturing strategy. The blanket database can include one or more blanket records. Each blanket record can include supplier name and a description for a commodity. The at least one server computer can be further configured to receive a desired commodity record from the one or more located commodity records from either the commodity database or the blanket database.

The at least one server computer can be further configured to transmit the desired commodity record in an electronic form. The electronic form is selected from the group consisting of a requisition, a shopping cart item and a request for quotation. The at least one server computer can be further configured to cause display of the one or more located commodity records. If no commodity records from the commodity database and the blanket database satisfy the one the one or more attributes, the purchasing strategy and the manufacturing strategy, then the at least one server computer can be configured to receive a request to change the one or more search attributes. If no commodity records from the commodity database and the blanket database satisfy the one the one or more attributes, the purchasing strategy and the manufacturing strategy, then the at least one server computer can be configured to receive a request to create a new requisition.

The at least one server computer can be further configured to create a new requisition. The one or more attributes are provided by a requisitioner. The purchasing and manufacturing strategies are provided by a buyer organization. The inventory item database is provided by the buyer organization.

According to a third embodiment of the present invention, a computer-implemented system for performing searching for products or services is disclosed. The system includes at least one client computer for communicating with at least one server computer. The at least one client computer can be configured to transmit a commodity database, the commodity database including one or more commodity records, each commodity record including supplier name, a description for a commodity, a commodity code and an inventory level for the commodity, transmit one or more search attributes, a purchasing strategy, and a manufacturing strategy, the purchasing strategy identifying one or more preferred suppliers based on the commodity code in each commodity record, the manufacturing strategy based on a target inventory level for a commodity described in at least one of the commodity records and search the commodity database to obtain one or more located commodity records that satisfy the one the one or more attributes, the purchasing strategy and the manufacturing strategy, the one or more located commodity records being relied upon to requisition products and services.

According to a fourth embodiment of the present invention, a program for performing searching for products and services is disclosed. The program includes instructions for receiving a commodity database, the commodity database including one or more commodity records, each commodity record including supplier name, a description for a commodity, a commodity code and an inventory level for the commodity, instructions for receiving one or more search attributes, a purchasing strategy, and a manufacturing strategy, the purchasing strategy identifying one or more preferred suppliers based on the commodity code in each commodity record, the manufacturing strategy based on a target inventory level for a commodity described in at least one of the commodity records, and instructions for searching the commodity database to obtain one or more located commodity records that satisfy the one the one or more attributes, the purchasing strategy and the manufacturing strategy, the one or more located commodity records being relied upon to requisition products and services.

The one or more attributes can be provided by a requisitioner. The purchasing and manufacturing strategies can be provided by a buyer organization. The inventory item database can be provided by the buyer organization.

The above embodiments and other embodiments; features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may be best understood with reference to the following description, taken in connection with the accompanying drawings:

FIG. 1 is a schematic diagram illustrating a system embodiment for implementing certain methods of the present invention;

FIG. 2A depicts a search flow in accordance with a search engine tool of the present invention;

FIG. 2B depicts a search flow in accordance with a search engine tool of the present invention; and

FIG. 3 depicts a search flow in accordance with a search engine tool of the present invention.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as representative basis for the claims and/or as a representative basis for teaching one skilled in the art to variously employ in the present invention.

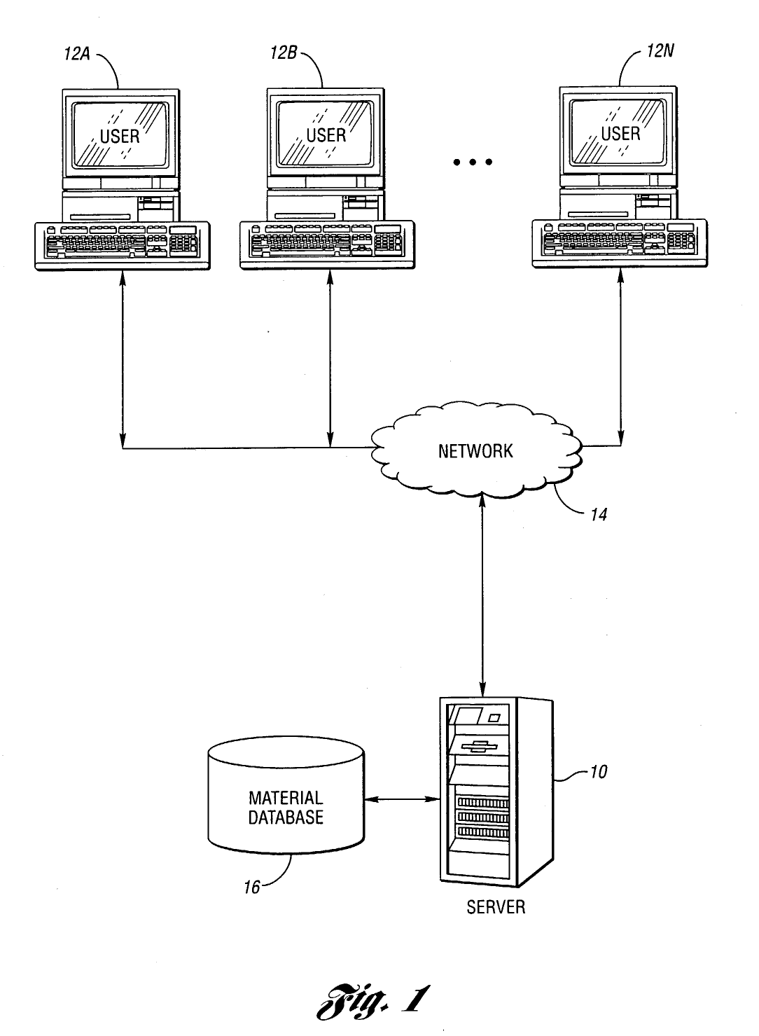

FIG. 1 is a schematic diagram illustrating a system embodiment for implementing certain methods of the present invention. It should be understood that the diagram can be modified, rearranged, deleted, added upon, or amplified based on a particular embodiment of the present invention.

FIG. 1 illustrates an at least one server computer 10 operably serving a plurality of client computers 12A-N, which can communicate with server computer 10 utilizing a TCP-IP communication protocol via network/LAN 14. Server computer 10 can be configured to operably store data to, and retrieve information from, at least one material database 16.

Search Engine Tool Functionality

The search engine tool includes functionality for a user, to search on-hand quantities for a specific inventoried item in one or more inventory organizations. The user can be a requisitioner, a process engineer, or a human resources requisitioner, for example. The user can submit a shop floor requisition if the on-hand quantities meet the user's demand. Otherwise, the user has the ability to submit a release against a Blanket PO.

The search engine tool includes the ability to return on-hand quantities by inventory organizations based on the item selected. The returned on-hand quantities can be restricted by the user's profile attributes. If an inventory is located, users can be directed to a Shop Floor Requisitioning System via a URL link on the portal page.

The search engine tool includes the ability to return items from the unified catalog, based on the items searched and selected. The returned items can be restricted by the user's profile and the blanket coverage. If a catalog item is found, the item can be added to the cart in Internet Procurement.

The search engine tool includes the ability to search a blanket purchase order by commodity category, based on a blanket purchase order coverage header table. The search can be restricted by the user's profile attributes. If a blanket match is found, the user can create a purchase requisition via core responsibility.

The search engine tool includes the ability to create non-catalog purchase requisitions. These requisitions are not covered by a blanket purchase order. Users can create a non-catalog purchase requisition and attach one or multiple suppliers for purchasing to issue request for quotations and sourcing.

The search engine tool includes the ability for users to search based on a user's profile setup. A user can requisition one or more inventory organizations. Therefore, if a user has more than one inventory organization enabled on their profile, they can identify the inventory organization for a requisition. Validation can occur when the user profile security has been delivered. The user can have the option to search by various primary parameters (in combination or individually): inventory organization, MTL_System₁₃ Items Master part Number, MTL_System_Items Master Description, UNSPSC code (in the MTL_System_Items table or the Unified Catalog), Manufacturers Name (i.e., Allen Bradley), Part Number (i.e., #K98099), suppliers catalog item description in Internet requisitioning unified catalog, Suppliers Name (i.e., Grainger), supplier site code (Grainger's GSDB code).

All inventory items can be placed on a blanket purchase order. There could potentially be multiple blanket purchase orders for one item number MTL_System_Items part number. The MTL_System_Items Master can also contain additional attribute part information (i.e., Manufacturer Name, Manufacturer part number). Each plant/inventory Organization can maintain their individual MTL_System_Item inventory. An item created in inventory can be assigned to all inventory organizations or specific inventory organizations/plants.

A line on the blanket purchase order can contain the MTL_System_Items Number, MTL_System_Item description, the MTL_System_Items Category, unit of measure and the unit price. The header can contain the supplier, supplier site and the inventory organizations that the blanket covers.

When a search is conducted, the first results can return a selected list of items based on the search criteria entered by the user, as stated above. Misspelled words can return a list similar to the search criteria entered, which can allow for user typographical errors. The user can select the correct item to be ordered. The search can return the current on-hand quantity in the inventory organization selected with the MTL_System_Items number, the MTL_System_Items description, the manufacturers part number attribute and the manufacturers attribute description. If the quantity on-hand is greater than zero, the user can be directed to the shop floor requisitioning (SFR) system via a URL link. If the quantity on-hand is less than zero, the user can be directed to the SFR system via a URL link. Order on release (OOR) items are optionally not used. Optionally, all items have an on-hand balance. The MTL_System_Items selected can be in the unified catalog with a blanket number referenced, which can restrict the users selection, based on the user's profiling and the Blanket Order inventory organization's coverage. The custom approved supplier list (ASL) workflow can generate an approved Standard PO, against the blanket order for the item selected, without buyer intervention.

If no match is found in the inventory or in the catalog, the user can search for coverage on a blanket. Blanket lines with a commodity and inventory organization coverage can be searched. If a match is found, the user can create a requisition to release off the blanket.

If no match is found above, the user can be directed to complete a free firm requisition. They can search for blankets within the core applications to see if coverage applies. The user can also see what the strategy is for a commodity if needed.

The user can be directed through the searching capabilities to minimize inventory and maximize leverages buyers have negotiated with suppliers through the blanket order agreements.

A system to implement the search engine tool functionality can include the following business guidelines:

User profile can restrict users to transact for particular tool Inventory Organization(s). The search engine can restrict the user from selecting inventory organizations based on the user's custom profile table.

The tool can execute the URL link and launch the SFR system or legacy systems when the search is completed. Links can be provided on the requisitioning portal via a URL.

The tool does not restrict the user from creating a requisition for an item with on-hand inventory, in a particular plant's inventory organization; or a release against an existing blanket purchase order for a particular item. The tool does not restrict a user from submitting a non-catalog free form requisition for an item, which may be in the unified catalog.

The requester can be restricted from searching the blanket orders within self service applications to release against, if the blanket order has only the coverage and MTL_System_Items Category (UNSPSC codes).

Inventory items can be included on a blanket. The part number, description, commodity and price can be on a blanket. All other part specific info can be in the item master.

The inventory items from the blanket purchase Orders can be displayed in the unified catalog.

Covisint catalog items can be on a blanket.

Line items with firm pricing can have a description, commodity, and price on the blanket.

Line items without a price can have a commodity and may or not have a description on the blanket.

The buyer and supplier can have separate lines on the catalog for a non-inventory item and an inventory item. The blanket cannot contain both inventory and non-inventory items as the coverage is at the header and does not distinguish between inventory and non-inventory.

A process for implementing the search engine tool functionality can include the following steps, not necessarily in order of execution:

1) The user can select the inventory organization for querying. This selection can be restricted to the inventory originations that user has access to.

2) The user can enter search parameters into the search inquiry screen. The user can search by one of the following: manufacturer (i.e., manufacturer's name, manufacturer's name and manufacturer's part number, manufacturer's name and manufacturer's description, or manufacturer supplier description), supplier (i.e., supplier name or supplier name and supplier site code), item master (item master part number or item master part description), or UNSPSC Code.

If no rows are found when searching by manufacture and supplier name, the user can search by phonetic representation of the entered spelling of the name.

3) The results from the various search possibilities can include displaying the current quantity on-hand for a given part in an inventory origination being searched.

4) If the current quantity on-hand is greater then zero a link to the SFR system can be provided.

5) If the current quantity on-hand is zero, a link to search blankets can be provided. If the inventory item is found in the catalog, then the user can create a requisition. If no blank is found then the user can create either a catalog requisition or non-catalog requisition.

Flow Chart Representation of Search Engine Tool

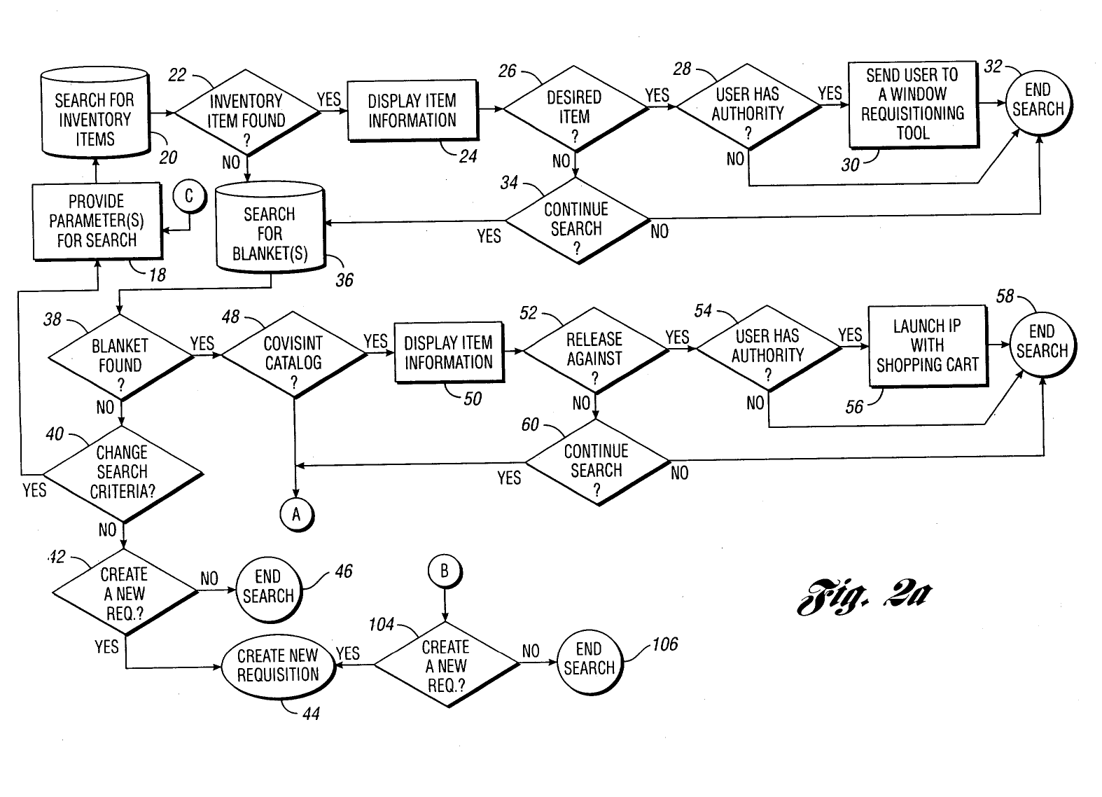

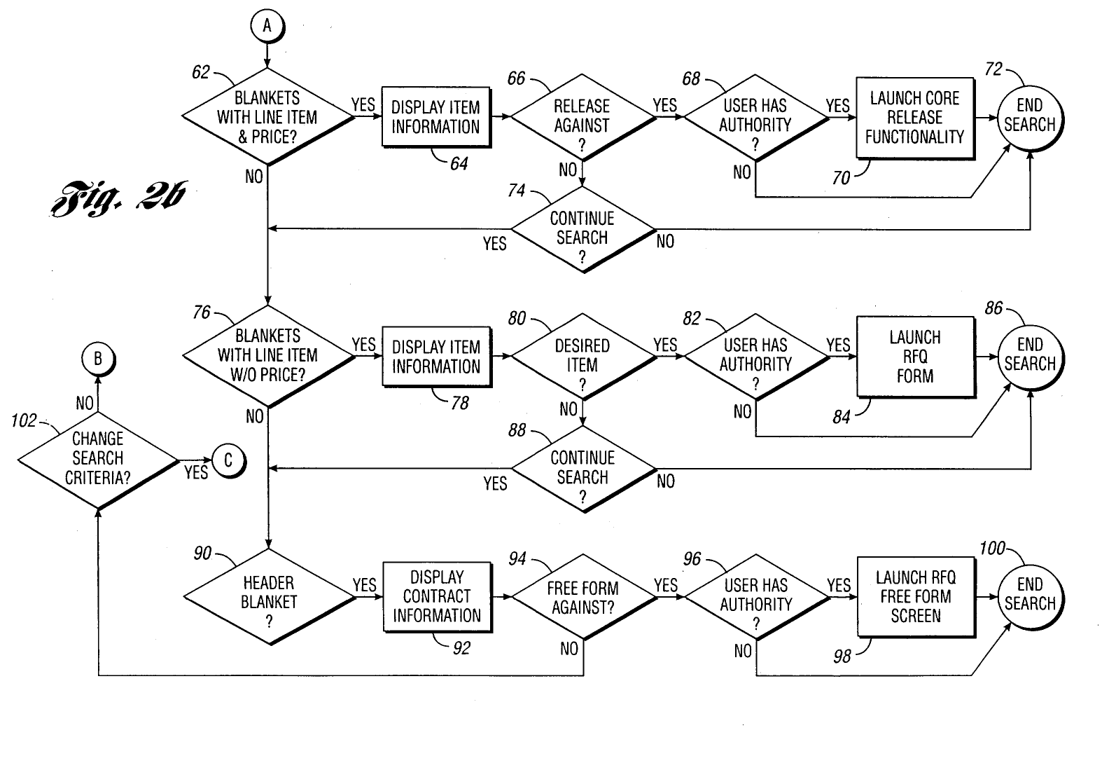

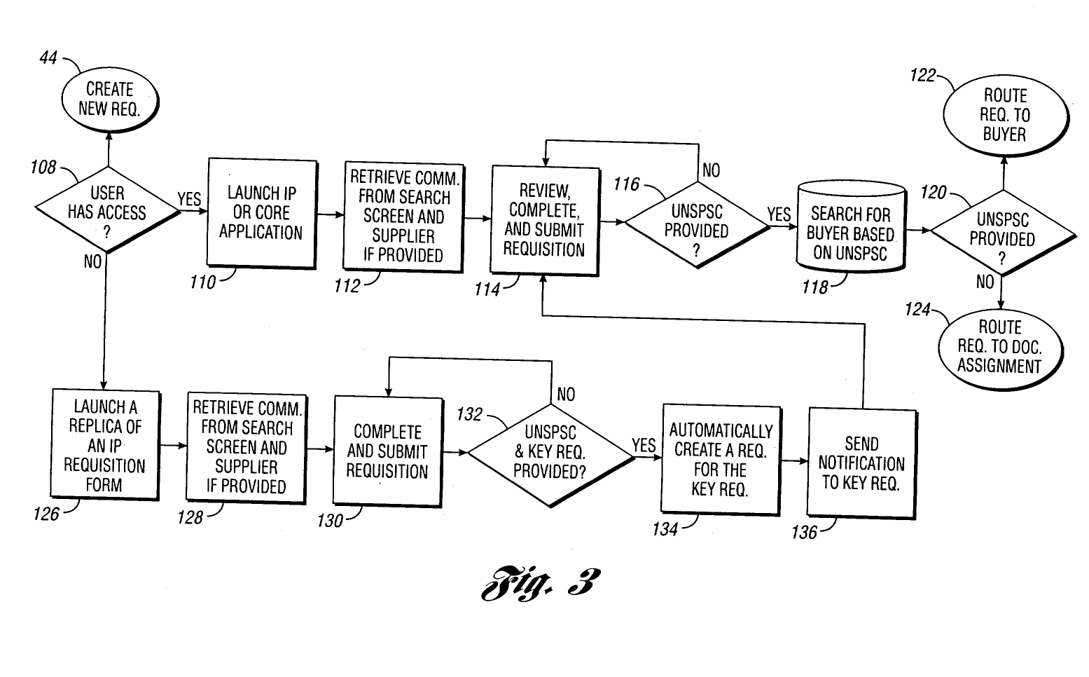

FIGS. 2A, 2B and 3 depict a search flow in accordance with a search engine tool of the present invention.

According to block 18 of FIG. 2A, a requisitioner provides at least one parameters for a search. Non-limiting examples of search parameters include manufacturer name, manufacturer part number, item master part number, description, UNSPSC code, UNSPSC description, supplier name, supplier site code, blanket number and location. As depicted by database block 20, the search engine searches for inventory items based on the provided search parameters. In certain embodiments, the priority of search terms is (1) part number (if provided) and (2) blanket number (if provided).

If an inventory item is found, item information is displayed to the requisitioner, as depicted by decision block 22 and block 24. If the item found is the item desired by the requisitioner, the search engine tool verifies if the requisitioner has authority, as depicted by decision blocks 26 and 28. If the requisitioner has authority, the requisitioner is directed to a window requisitioning tool and the search ends, as depicted by block 30 and end point 32.

If the item found is not the item desired by the requisitioner, the requisitioner is prompted to continue with the search, as depicted by block 34. If the requisitioner does not continue the search, the search ends, as depicted by end point 32. If the requisitioner continues the search, the search engine searches for blankets based on the provided search parameters, as depicted by database block 36.

According to decision blocks 38 and 40, if a blanket is not found, the requisitioner is prompted to change the search parameters. If the requisitioner decides to change the search parameters, the requisitioner can do so according to block 18. If the requisitioner decides not to change the search parameters, the requisitioner is prompted to decide whether to create a new requisition, as depicted in decision block 42. If yes, a new requisition can be created, as depicted by circle 44 and described in more detail on FIG. 3. If the requisitioner decides not to create a new requisition, then the search ends as depicted by end point 46.

If a blanket is found, the search engine tool checks whether the item exists in a Covisint catalog, as depicted by decision block 48. If it does exist, item information is displayed to the requisitioner, as depicted by block 50. According to decision block 52, the search engine tool prompts the requisitioner as to whether the item should be released against the Covisint catalog. If yes, the search engine tool verifies whether the requisitioner has authority, as depicted in block 54. If the requisitioner is authorized, an Internet procurement shopping cart is launched as depicted by block 56 and then the search ends as depicted by end point 58. If the requisitioner is not authorized, the search ends as depicted by end point 58.

If the requisitioner decides not to release against, the requisitioner is prompted to continue with the search, as depicted by block 60. If the requisitioner does not continue the search, the search ends, as depicted by end point 58. If the requisitioner continues the search, the search engine tool checks whether the item exists in a blanket with line items and price, and the item is not in inventory, as depicted by decision block 62.

If a blanket with line items and price is found, item information is displayed to the requisitioner, as depicted by block 64. According to decision block 66, the search engine tool prompts the requisitioner as to whether the item should be released against the blanket with line items and price. If yes, the search engine tool verifies whether the requisitioner has authority, as depicted in block 68. If the requisitioner is authorized, core release functionality is launched as depicted by block 70 and then the search ends as depicted by end point 72. If the requisitioner is not authorized, the search ends as depicted by end point 72.

If the requisitioner decides not to release against, the requistioner is prompted to continue with the search, as depicted by block 74. If the requisitioner does not continue the search, the search ends, as depicted by end point 72. If the requisitioner continues the search, the search engine tool checks whether the item exists in a blanket with line items and no price, and the item is not in inventory, as depicted by decision block 76.

If a blanket with line items and no price is found, item information is displayed to the requisitioner, as depicted by block 78. According to decision block 80, the search engine tool prompts the requisitioner as to whether the item is the desired item. If yes, the search engine tool verifies whether the requisitioner has authority, as depicted in block 82. If the requisitioner is authorized, a RFQ form is launched as depicted by block 84 and then the search ends as depicted by end point 86. If the requisitioner is not authorized, the search ends as depicted by end point 86.

If the requisitioner decides that the item information does not reflect the desired item, the requistioner is prompted to continue with the search, as depicted by block 88. If the requisitioner does not continue the search, the search ends, as depicted by end point 86. If the requisitioner continues the search, the search engine tool checks whether any items exist in a header blanket, as depicted by decision block 90.

If a header blanket is found, item information is displayed to the requisitioner, as depicted by block 92. According to decision block 94, the search engine tool prompts the requisitioner as to whether a free form should be created against the header blanket. If yes, the search engine tool verifies whether the requisitioner has authority, as depicted in block 96. If the requisitioner is authorized, a requisition free form screen is launched as depicted by block 98 and then the search ends as depicted by end point 100. If the requisitioner is not authorized, the search ends as depicted by end point 100.

If the requisitioner decides not to create a free form against the header blanket, the requistioner is prompted to continue with the search by changing the search criteria, as depicted by block 102. If the requisitioner does not continue the search, the requisitioner is prompted to create a new requisition, as depicted in decision block 104. If the requisitioner chooses not to create a new requisition, the search ends, as depicted by end point 106. If the requisitioner chooses to create a new requisition, a new requisition can be created, as depicted by circle 44 and described on more detail on FIG. 3.

FIG. 3 is a flow chart depicting a process for creating a new requisition in accordance with an embodiment of the present invention. As depicted by decision block 108, the search tool verifies that the user has access to new requisition creation. If the user has access, an Internet procurement or core application is launched, as depicted by block 110. As depicted by block 112, the search tool retrieves a commodity from a search screen and also suppliers if provided. As depicted by block 114, the requisition is reviewed, completed, and submitted. As depicted by decision block 116, if the UNSPSC is not provided in the requisition, then it must be added and then the requisition is re-submitted. If the UNSPSC is provided, then the search tool searches for a buyer based on UNSPSC by using a relationship table, as depicted by database block 118.

As depicted by decision block 120 and circle 122, if a buyer is found, the requisition is routed to the buyer. If a buyer is not found, the requisition is routed to document assignment.

If the user does not have access to create new requisitions, a replica of the Internet procurement requisition form is launched, as depicted by block 126. As depicted by block 128, the search tool retrieves a commodity from a search screen and also suppliers if provided. As depicted by block 130, the requisition is reviewed, completed, and submitted. The key requisitioner is submitted with the requisition. As depicted by decision block 132, if the UNSPSC and the key requisitioner is not provided in the requisition, then they must be added and then the requisition is re-submitted. If the UNSPSC and key requisitioner is provided, then the search tool automatically creates a requisition for the key requisitioner, as depicted in block 134. As depicted in block 136, a notification is then sent to the requisitioner and the process is transferred to block 114.

Search Scenarios

The following descriptions provide search scenarios for utilizing search tool functionality in accordance with embodiments of the present invention.

According to a first search scenario, a process engineer searches for “Hammer”. The scenario includes the following assumptions: (1) no Covisint catalog items for Hammer exist, (2) the requisitioner's location is location A, (3) the process engineer does not have access to catalog shopping or free-form functionality, (4) there are two hammers in the inventory of location A: Hammer A (balance on hand (B.O.H.) equals 10 and supplier is Hammer Corp.) and Hammer B (B.O.H. equals 5 and supplier is Hammer & Hammer), (5) the United Nations Standard Product Service Code (UNSPSC) for Hammers A and B is 27111602, (6) the UNSPSC for the purchasing and/or manufacturing strategy in the strategy development system (SDS) is 27110000, and (7) the possible suppliers include Hammer Corp., Hammer & Hammer, ABC Tools, and Grainger. It should be understood that commodity codes other than UNSPSCs can be used in accordance with the present invention as longs they are coded that identify the products and services that an organization might purchase through a given time period.

According to a first example of the first search scenario, the requisitioner provides the word “Hammer” in the description field. The search engine tool can automatically suggest a list of UNSPSCs that have hammer in the description. The list can be displayed on a graphical user interface (GUI) through a drop down menu with the following information:

TABLE 1

| UNSPSC | UNSPSC Description |
|---|---|
| 27112705 | Demolition Hammers |
| 20111603 | Hammer Drill |
| 21102006 | Hammer Mills |
| 27111602 | Hammer |
| All | All |
| <Blank> | <Blank> |

The GUI can also include, but is not limited to, description (hammer) and location (location A).

The requisitioner is provided with the ability to click on the UNSPSC and the search tool can provide the UNSPSC description by level. For example, if the UNSPSC is 27111602, the following description can be returned: Tools and General Machinery (27), Hand Tools (11), Forming Tools (16), and Hammers (2).

According to this example, the requisitioner can leave the UNSPSC <Blank>, so that the only parameter provided is the Description “Hammer” and the Location “location A”. The system can perform the search in the location A Inventory and can find two parts for location A with the Description “Hammer”: hammer A (B.O.H.=10 and Supplier=Hammer Corp.) and hammer B (B.O.H.=5 and Supplier=Hammer & Hammer). The requisitioner can have a filter and sort capability to manage the results. Upon selecting a hammer from hammer A and B, the system can automatically launch a window requisitioning application if the user has access.

According to a second example of the first search scenario, the requistioner changes the location from location A to location B and provides the word “Hammer” in the description field. The search tool can automatically suggest a list of UNSPSCs that have hammer in the description. For example, the list can be displayed on a graphical user interface (GUI) through a drop down menu with the following information:

TABLE 2

| UNSPSC | UNSPSC Description |
|---|---|
| 27112705 | Demolition Hammers |
| 20111603 | Hammer Drill |
| 21102006 | Hammer Mills |
| 27111602 | Hammer |
| All | All |
| <Blank> | <Blank> |

The GUI can also include, but is not limited to, description (hammer) and location (location B).

The requisitioner is provided with the ability to click on the UNSPSC code and the system should provide the UNSPSC description by level. For example, if the UNSPSC is 27111602, the following description can be returned: Tools and General Machinery (27), Hand Tools (11), Forming Tools (16), and Hammers (2).

According to this example, the requisitioner can leave the UNSPSC <Blank>, so that the only parameter provided is the Description “Hammer” and the Location=location B.

The search engine tool can perform the search in the location A Inventory and can find two parts for location A with the Description “Hammer”: hammer A (B.O.H.=10 and supplier=Hammer Corp.) and hammer B (B.O.H.=5 and supplier=Hammer & Hammer). The requisitioner can have a filter and sort capability to manage the results. Upon selecting a hammer from hammer A and B, the system can automatically launch a window requisitioning application if the user has access.

The system can also perform the search in the location B inventory and may not find any item with the description “Hammer”. If so, the search engine tool automatically searches through catalogs and blanket orders. However, hammers do not exist in these sources either. Consequently, the search engine tool can display the following: No items found; create a new requisition. If the requisitioner clicks on create a new request, the search engine tool can verify if the user has access.

According to a third example of the first search scenario, the requisitioner selects UNSPSC 27111602 from the drop down menu of the first example. In response, the search tool automatically suggests suppliers in SDS. The search tool can provide a list of suppliers and supplier sites based on the commodity, i.e. suppliers=Hammer Corp., Hammer & Hammer, ABC Tools, and Grainger. The system can perform a search in the Location A inventory and return two parts from location A with the Description Hammer and UNSPSC 27111602: hammer A (B.O.H.=10 and Supplier=Hammer Corp.) and hammer B (B.O.H.=5 and Supplier=Hammer & Hammer).

According to a fourth example of the first search scenario, the requisitioner selects UNSPSC 27111602 from the drop down menu of the first example. In response, the search tool automatically suggests suppliers in SDS. The requisitioner then selects the supplier “Grainger” that does not have “Hammers” in the requisitioner's inventory.

According to the fourth example, the search tool can perform a search in the location A inventory using the description “Hammer”, UNSPSC 27111602 and supplier Grainger. The search. tool will not be able to locate any item for the provided combination, but suggests other items based on description and UNSPSC.

The requisitioner is provided with the ability to click on continue search if the existing items are not the desired items. The system can search through the catalogs and blankets and if there are no results, the following can be displayed: No items found; create a new requisition.

According to a second search scenario, a process engineer searches for “Hammer”. The scenario includes the following assumptions: (1) a Covisint catalog item for Hammer exists, (2) the requisitioner's location is location A, (3) the process engineer does not have access to catalog shopping or free-form functionality, (4) there are two hammers in the inventory of location A: Hammer A (B.O.H. equals 10 and Supplier is Hammer Corp.) and Hammer B (B.O.H. equals 5 and Supplier is Hammer & Hammer), (5) the UNSPSC for Hammers A and B is 27111602, (6) the UNSPSC for the strategy in SDS is 27110000, (7) the possible suppliers include Hammer Corp., Hammer & Hammer, ABC Tools, and Grainger, and (8) Grainger has a hammer in the Covisint catalog.

According to the second search scenario, if the requisitioner provides the word “Hammer” in the description field, the search tool can automatically suggest a list of UNSPSCs that have hammer in the description. The list can be displayed in accordance with Table 1. According to this scenario, the requisitioner selects UNSPSC 27111602 and the search tool can automatically suggest suppliers in SDS. The requisitioner can select the supplier “Grainger” that does not have the item in inventory but has a hammer in their catalog. The requisitioner can click on the UNSPSC codes provided in table 1 to provide the UNSPSC description by level. The search tool can provide a list of suppliers and supplier sites based on the commodity, i.e. suppliers=Hammer Corp., Hammer & Hammer, ABC Tools, and Grainger.

According to the second scenario, the search tool performs the search in location A using description “Hammer”, UNSPSC 27111602 and supplier “Grainger”. The search tool does not find any items for the provided combination, but can suggest other items based on description and UNSPSC: hammer A (B.O.H.=10 and Supplier=Hammer Corp.) and hammer B (B.O.H.=5 and Supplier=Hammer & Hammer).

If the process engineer analyzes the hammers that are in inventory and discovers that the items do not support the engineer's need, the engineer can click on continue search. Accordingly, the system starts to search through the Covisint catalog and finds a Hammer in the Grainger catalog. The system can show the following result:

TABLE 3

| Description | Supplier | Price | UNSSPSC |
|---|---|---|---|
| Hammer ABC | Hammer Corp. | 2.50 | 27111692 |

If this is the desired item, the Requisitioner can click on the item and the system can automatically launch a shopping cart in Internet procurement with the item.

The requisitioner can also click on continue search if the existing item is not the desired item, the search tool can search through blanket purchase agreements. If no items are found, the following message can be displayed: no items found; create a new requisition.

According to a third search scenario, a process engineer searches for “Hammer”. The scenario includes the following assumptions: (1) a Covisint catalog item for Hammer exists, (2) the requisitioner's location is location A, (3) the process engineer does not have access to catalog shopping or free-form functionality, (4) there are two hammers in the inventory of location A: hammer A (B.O.H. equals 10 and Supplier is Hammer Corp.) and hammer B (B.O.H. equals 5 and Supplier is Hammer & Hammer), (5) the UNSPSC for Hammers A and B is 27111602, (6) the UNSPSC for the strategy in SDS is 27110000, (7) the possible suppliers include Hammer Corp., Hammer & Hammer, ABC Tools, and Grainger, and (8) Tools Corp. has a “Hammer” in the Covisint catalog, but Tools Corp. is not in the SDS strategy.

According to the third search scenario, if the requisitioner provides the word “Hammer” in the description field, the search tool can automatically suggest a list of UNSPSCs that have hammer in the description. The list can be displayed in accordance with Table 1. According to this scenario, the requisitioner selects UNSPSC 27111602 and the search tool can automatically suggest suppliers in SDS.

The requisitioner can select the supplier “Grainger” that does not have the item in inventory but has a hammer in their catalog. The requisitioner can click on the UNSPSCs provided in Table 1 to provide the UNSPSC description by level. The system can provide a list of suppliers and supplier sites based on the commodity, i.e. suppliers=Hammer Corp., Hammer & Hammer, ABC Tools, and Grainger.

According to the third scenario, the search tool performs the search in location A using description “Hammer”, UNSPSC 27111602 and supplier “Grainger”. The search tool does not find any items for the provided combination, but can suggest other items based on description and UNSPSC: hammer A (B.O.H.=10 and Supplier=Hammer Corp.) and hammer B (B.O.H.=5 and Supplier=Hammer & Hammer).

If the process engineer analyzes the hammers that are in inventory and discovers that the items do not support the engineer's need, the engineer can click on continue search. The search tool starts searching through the Covisint catalog. The search tool does not locate any item in the catalog for the provided combination (i.e. Hammer and Grainger), but suggests other items found in the catalog based on description and UNSPSC.

According to the third search scenario, the search tool suggests the Hammer found in the “Tools Corporation” Catalog:

TABLE 4

| Description | Supplier | Price | UNSPSC |
|---|---|---|---|
| Hammer ABC | Tools Corporation | 2.50 | 27111602 |
| | Grainger | | 27111602 |

If this is the desired item, the Requisitioner can click on the item and the search tool can automatically launch a shopping cart in IP with the item.

The requisitioner can also click on continue search if the existing item is not the desired item, the search tool can search through blanket purchase agreements. If no items are found, the following message can be displayed: no items found; create a new requisition.

According to a fourth search scenario, a requisitioner searches for a “Pen”. The scenario includes the following assumptions: (1) the pen item is not in inventory but exists in a catalog, (2) the requisitioner location is location C, (3) the following catalog items exist:

TABLE 5

| Description | Supplier | Price | UNSPSC |
|---|---|---|---|
| Ball Point Blue Pen | BIC | 0.50 | 47121704 |
| Rollerball Black Pen | BIC | 0.30 | 47121701 |
| Rollerball Blue Pen | Office Max | 0.45 | 47121704 |
| Ball Point Black Pen | Office Max | 0.25 | 47121701 |
| Ball Point Pen | Off. Supp. ABC | 0.10 | 47121701 |

(4) the UNSPSC for the Pens that are in the catalogs are 44121704 for Ball point pens, and 44121701 for Rollerball pens, (5) the UNSPSC for the strategy in SDS is 44121700, and (6) suppliers include Office Max and BIC.

According to a first example of the fourth search scenario, the requisitioner provides the word “Pen” in the description field. The search tool can automatically suggest a list of UNSPSCs having Pen in the description. The list can be displayed on a GUI through a drop down menu with the following information:

TABLE 6

| UNSPSC Code | UNSPSC Description |
|---|---|
| 44121704 | Ball point pens |
| 44121701 | Rollerball pens |
| All | All |
| <Blank> | <Blank> |

The GUI can also include, but is not limited to, description (pen) and location (location C).

According to this example, the requisitioner selects UNSPSC 44121704 and the search tool can automatically suggest suppliers in SDS, if any exist. The search tool can provide the UNSPSC description by level. For example, if the UNSPSC is 44121704, the following descriptions can be returned: Office Equipment and Accessories and Supplies (44), Office Equipment and Accessories and Supplies (12), writing instruments (17), and ball point pens (04).

The search tool can provide a list of suppliers and supplier sites based on the commodity. According to this example, the search tool does not locate an inventory for location C, so the search tool automatically searches through the catalogs for pens and UNSPSC 44121704. The search tool can return the following results:

TABLE 7

| Description | Supplier | Price | UNSPSC |
|---|---|---|---|
| Ball Point Blue Pen | BIC | 0.50 | 47121704 |
| Rollerball Blue Pen | Office Max | 0.45 | 47121704 |

If the desired item appears in Table 7, the requisitioner can click on the item and the search tool can automatically launch the Shopping Cart in Internet procurement with the item. The requisitioner has the ability to click on continue search if the existing items are not the desired items. The search tool can search through the blankets and if nothing is found, the search tool can display: no items found; create a new requisition.

According to a second example of the fourth search scenario, the requisitioner selects UNSPSC 44121704 from the drop down menu of the first example. In response, the system does not find an inventory for location C. In such case, the search tool automatically searches through Catalogs for “Pens”. The search tool can return the following results:

TABLE 8

| Description | Supplier | Price | UNSPSC |
|---|---|---|---|
| Ball Point Blue Pen | BIC | 0.50 | 47121704 |
| Rollerball Black Pen | BIC | 0.30 | 47121701 |
| Rollerball Blue Pen | Office Max | 0.45 | 47121704 |
| Ball Point Black Pen | Office Max | 0.25 | 47121701 |
| Ball Point Pen | Off. Supp. ABC | 0.10 | 47121701 |

If the desired item appears in Table 8, the requisitioner can click on the item and the search tool can automatically launch the Shopping Cart in Internet procurement with the item. The requisitioner has the ability to click on continue search if the existing items are not the desired items. The search tool can search through blankets and if nothing is found, the search tool can display: no items found; create a new requisition.

According to a third example of the fourth search scenario, the requisitioner provides the word “Ball Point Pen” in the description field. The requisitioner then selects UNSPSC 44121704 from the drop down menu of the first example. The search tool provides a list of suppliers from SDS, i.e. Office Max and BIC, and the requisitioner selects BIC.

The search tool does not find an inventory for location C, so the search tool automatically searches through the catalogs for Ball Point Pens with a UNSPSC of 44121701 being supplied by BIC. The search tool does not find any item for the provided combination, but can suggest the Office Max or Office Supplies catalog items based on the combination of description and UNSPSC. The search tool can return the following results:

TABLE 9

| Description | Supplier | Price | UNSPSC |
|---|---|---|---|
| Ball Point Black Pen | Office Max | 0.25 | 47121701 |
| Ball Point Pen | Off. Supp. ABC | 0.10 | 47121701 |

If the desired item appears in Table 9, the requisitioner can click on the item and the search tool can automatically launch the Shopping Cart in Internet procurement (IP) with the item. The requisitioner has the ability to click on continue search if the existing items are not the desired items. The search tool can search through blankets and if nothing is found, the system can display: no items found; create a new requisition.

According to a fourth example of the fourth search scenario, the requisitioner selects the UNSPSC 44121701 and does not provide a description or a supplier.

The search tool does not find an inventory for location C, so the system automatically searches through the catalogs for all the items with the UNSPSC 44121701. The search tool can return the following results:

TABLE 10

| Description | Supplier | Price | UNSPSC |
|---|---|---|---|
| Rollerball Black Pen | BIC | 0.30 | 47121701 |
| Ball Point Black Pen | Office Max | 0.25 | 47121701 |
| Ball Point Pen | Off. Supp. ABC | 0.10 | 47121701 |

If the desired item appears in Table 10, the requisitioner can click on the item and the search tool can automatically launch the Shopping Cart in IP with the item. The requisitioner has the ability to click on continue search if the existing items are not the desired items. The search tool can search through blankets and if nothing is found, the search tool can display: no items found; create a new requisition.

According to a fifth search scenario, a human resources requisitioner searches for a “financial analyst” to work in the finance department for three years. Since the “financial analyst” is an agency employee, the supplier “finance consulting” does not have a Covisint catalog. The scenario includes the following assumptions: (1) a blanket is set up for the supplier with the price of 5,000 USD per month, (2) the requisitioner location is location D, (3) the blanket number is 5001200100025867, (4) a blanket item is as follows:

TABLE 11

| Description | Supplier | Price | UOM | UNSPSC |
|---|---|---|---|---|
| Financial Analyst | Finance | 5,000.00 | MO | 80111600 |
| Senior | Consultant | | | |

(5) the UNSPSC for the service in the blanket is 80111600—Temporary personnel services, and (6) there is no strategy in SDS for Temporary Personnel services.

According to a first example of the fifth search scenario, the requisitioner already knows the blanket order number since the blanket was established for the requisitioner specific need. The requisitioner provides the blanket number. Accordingly, the search tool automatically searches for the required blanket and displays the details to the requisitioner as in Table 11.

If the desired item is displayed, the requisitioner can click on the item and the search tool can automatically launch the core release functionality. The system can search through blankets and if nothing is found, the search tool can display: no items found; create a new requisition.

According to a second example of the fifth search scenario, the requisitioner does not remember the blanket order number but knows the supplier for this service. Moreover, the requisitioner does not remember the UNSPSC Code. Therefore, the search is performed using the supplier criteria.

Since the requisitioner just typed the Supplier Name, the search tool automatically searches through all the items for the Specific Supplier. According to the second example, the search tool does not find any item in inventory and also does not find any catalog item for this specific supplier, but the search tool finds the Line Item priced Blanket, as depicted in Table 11.

If the desired item is displayed, the requisitioner can click on the item and the search tool can automatically launch a core release functionality. The search tool can search through blankets and if nothing is found, the search tool can display: no items found; create a new requisition.

According to a third example of the fifth search scenario, the requisitioner does not remember the blanket order number or the supplier, so the description is the only search field. Accordingly, the search tool automatically searches through all the items based on the description. The search tool does not find any item in inventory or in any catalog item for the specific supplier, but the search tool can find a line item priced blanket. The information relating to the blanket can be displayed to the requisitioner.

If the desired item is displayed, the requisitioner can click on the item and the system can automatically launch the core release functionality. The search tool can search through the Blankets and if nothing is found, the system can display: no items found; create a new requisition.

According to a fourth example of the fifth search scenario, the requisitioner does not remember the blanket order number or the supplier so the description is the only search field. However, the requisitioner selects the wrong UNSPSC.

Since the requisitioner typed the description and the UNSPSC, the search tool automatically searches through all the items based on the description and UNSPSC. According to this example, the search tool does not find any record with the search combination. As a result, the search tool automatically performs the search again, using just the description field, showing the results as depicted in Table 11.

If the desired item is displayed, the requisitioner can click on the item and the search tool can automatically launch the core release functionality. The search tool can search through blankets and if nothing is found, the search tool can display: no items found; create a new requisition.

According to a sixth search scenario, a requisitioner searches for a “Window Cleaning Service” for a new building. A blanket PO with a specific line item for this service exists, but without price because the price may change by location. The scenario includes the following assumptions: (1) the requisitioner location is location C, (2) the blanket item is as follows:

TABLE 12

| Description | Supplier | Price | UOM | UNSPSC |
|---|---|---|---|---|
| Window Cleaning | Cleaning Corp. | | | 76111504 |

(3) UNSPSC for the Service in the Blanket is 76111504—Window or window blind cleaning services; 76—Industrial Cleaning Services; 11—Cleaning and janitorial services; 15—General building and office cleaning services; and 04—Window or window blind cleaning services, and (4) the suppliers are Cleaning Corp. and ABC Cleaning Services.

The requisitioner does not provide a description and inputs a UNSPSC as the search parameter. The search tool provides a list of suppliers for the UNSPSC by location. According to this scenario, the requisitioner does not select a supplier. The search tool can provide a list of suppliers and supplier sites based on the commodity. The list can be generated from SDS. The suppliers can be Cleaning Corp. and ABC Cleaning Services.

According to this scenario, the search tool searches for any item in Inventory, but may not locate any items fitting the search term. However, a blanket with price for blind service (UNSPSC 76111504) can exist. Accordingly, the search tool provides the requisitioner an option of the blind service with a line item priced based on the search performed by commodity:

TABLE 13

| Description | Supplier | Price | UOM | UNSPSC |
|---|---|---|---|---|
| Blind Cleaning | ABC Cleaning | 15.00 | Hour | 76111504 |
| Services | | | | |

The requisitioner can look at the service description and can identify whether the item returned is the desired item. If not, the requisitioner can select a “Continue Search Option” button. Accordingly, the search tool can continue the search through the blankets with line items without price based on the UNSPSC and can present the results found in Table 12.

If the desired item is displayed, the requisitioner can click on the item and the search tool can automatically launch the RFQ functionality since a price does not exist. The system can automatically fill all the information on the RFQ form based on the item selected in the search.

According to a seventh search scenario, a requisitioner searches for an “Engineering Service” for a new program development. The scenario includes the following assumptions: (1) the requisitioner location is location D, (2) the header blanket is as follows:

TABLE 14

| Description | Supplier | Price | UOM | UNSPSC |
|---|---|---|---|---|
| Engineering Services | MSX | | | 81100000 |
| Prototype Services | Carron & Co | | | 81100000 |
| Prototype Parts | Roush | | | 81100000 |
| Design Development | MSX | | | 81100000 |

(3) the UNSPSCs for the services on the blanket are: 81100000—Professional engineering services; 81—Engineering and Research and Technology Based Services; and 11—Professional engineering services, and (4) the suppliers in SDS fir engineering are MSX and Carron & Co.

According to a first example of the seventh search scenario, the requisitioner provides the supplier MSX as the search parameter. The search tool searches for MSX but does not find any item in Inventory. Next, the search tool searches for blankets that contain line items for MSX, however none exist. The search tool then searches for header-only blankets and finds two that can be displayed as follows:

TABLE 15

| Description | Supplier | Price | UOM | UNSPSC |
|---|---|---|---|---|
| Engineering Services | MSX | | | 81100000 |
| Design Development | MSX | | | 81100000 |

The requisitioner can then choose the engineering services blanket and the search tool can automatically launch a requisition free form screen with data extracted from the blanket. At this point, the system can check if the user has access to a free form screen. If the user does not have access, the search tool provides the message “You are not authorized to use this functionality”. If the existing items are not the desired items, the requisitioner can click on “Continue Search”. At this point, the search tool can display that no items were found, as the header only is the last option.

According to a second example of the seventh search scenario, the requisitioner provides the description prototype parts and the UNSPSC as the search parameters. The search tool displays the list of suppliers and the requisitioner selects MSX.

The search tool searches for any items in inventory, but does not locate any. The search tool then searches for blankets that contain line items for MSX and does not locate any items. The search tool then searches for header only blankets and does not locate any blanket for prototype parts and MSX. At this point, the search tool automatically performs the search again based on the Description and UNSPSC and obtains the following results:

TABLE 16

| Description | Supplier | Price | UOM | UNSPSC |
|---|---|---|---|---|
| Prototype Parts | Roush | | | 81100000 |

The requisitioner can select the Roush blanket and the search tool can automatically launch a requisition free form screen with data extracted from the blanket. At this point, the search tool can check if the user has access to a free form screen. If the user does not have access, the search tool provides the message “You are not authorized to use this functionality”. If the existing items are not the desired items, the requisitioner can click on a “Continue Search” button. At this point, the search tool can display that no items were found, as the header only is the last option.

According to an eighth search scenario, a requisitioner searches for a “prototype development service”. The requisitioner needs to have the service provided by MSX due to the timing and technology required. The search tool does not find any blanket that supports the need and creates a new request. The scenario includes the following assumptions: (1) the requisitioner location is location D, (2) the header blanket is as follows:

TABLE 17

| Description | Supplier | Price | UOM | UNSPSC |
|---|---|---|---|---|
| Engineering Services | Carron & Co | | | 81100000 |
| Prototype Parts | Roush | | | 81100000 |

(3) the UNSPSCs for the service on the blanket are: 81100000—Professional engineering services; 81—Engineering and Research and Technology Based Services; and 11—Professional engineering services, and (4) the suppliers in SDS for engineering are MSX, Carron & Co. and Rousch.

According to a first example of the eighth search scenario, the requisitioner provides the description “prototype development” and a UNSPSC. The requisitioner selects the supplier MSX.

The search tool searches for an item fitting the search criteria, but does not locate any item in inventory. The search tool searches for blankets that contain line items for MSX and UNSPSC 811100000 and does not locate any item. The search tool then searches for header only blankets and does not find any blanket for prototype development and MSX. At this point, the search tool automatically performs the search again based on the description and UNSPSC and obtains the following results:

TABLE 18

| Description | Supplier | Price | UOM | UNSPSC |
|---|---|---|---|---|
| Prototype Parts | Roush | | | 81100000 |

The search tool does not find any other items with a blanket PO that matches the selected criteria and can display the following message: no items found; create a new requisition. The requisitioner can click on a “Create a new requisition Link” button and the search tool can automatically launch core requisitioning functionality to automatically populate the UNSPSC and supplier fields based on the parameters selected. The search tool can require the UNSPSC selection prior to launching the requisitioning functionality. In such a case, the requisitioner completes the requisition and submits it for approval. After the approval the search tool can automatically send the request to the buyer based on the UNSPSC by Buyer by Location table.

According to a second example, the requisitioner provides the description “prototype development” and a UNSPSC. The requisitioner selects the supplier MSX.

The search tool searches and does not locate any items in inventory. The search tool searches for blankets that contain line items for MSX and UNSPSC 811100000 and does not locate any items. The search tool then searches for header only blankets and does not find any blanket for prototype development and MSX. At this point, the search tool automatically performs the search again based on the description and UNSPSC and obtains the results found in Table 18.

The search tool does not find any other item with a blanket PO that matches the selected criteria and can display the following message: no items found; create new requisition. The requisitioner can click on a “Create a new requisition Link” button. The search tool can identify if the user does not have access to the requisitioning tool and can display the message “Sorry, you do not have access to this application”. The search tool can provide a replica of a requisitioning form that can be automatically populated with the description, supplier and UNSPSC provided in the parameters and should also request a key requisitioner ID. The requisitioner can complete the replica of the requisition form. The search tool can automatically generate a notification to the key requisitioner and automatically create a requisition to the key requisitioner. The key requisitioner can review the requisition and submit it to approval. After the approval, the search tool can automatically send the request to the buyer based on the UNSPSC by Buyer by Location table.

While the best mode for carrying out the invention has been described in detail, those familiar with the art to which this invention relates will recognize various alternative designs and embodiments for practicing the invention as defined by the following claims.

What is claimed:

1. A computer-implemented method for performing searching for products and services, the method comprising:
receiving a commodity database, the commodity database including one or more commodity records, each commodity record including supplier name, a description for a commodity, a commodity code and an inventory level for the commodity;
receiving one or more search attributes, a purchasing strategy, and a manufacturing strategy, the purchasing strategy identifying one or more preferred suppliers based on the commodity code in each commodity record, the manufacturing strategy based on a target inventory level for a commodity described in at least one of the commodity records; and
searching the commodity database to obtain one or more located commodity records that satisfy the one the one or more attributes, the purchasing strategy and the manufacturing strategy.

2. The method of claim 1 further comprising receiving a desired commodity record from the one or more located commodity records.

3. The method of claim 1 further comprising searching a blanket database to obtain one or more located commodity records that satisfy the one the one or more attributes, the purchasing strategy and the manufacturing strategy, the blanket database including one or more commodity records, each commodity record including supplier name and a description for a commodity.

4. The method of claim 3 further comprising receiving a desired commodity record from the one or more located commodity records from either the commodity database or the blanket database.

5. The method of claim 2 further comprising transmitting the desired commodity record in an electronic form.

6. The method of claim 5 wherein the electronic form is selected from the group consisting of a requisition, a shopping cart item and a request for quotation.

7. The method of claim 5 further comprising causing display of the one or more located commodity records.

8. The method of claim 4 further comprising if no commodity records from the commodity database and the blanket database satisfy the one the one or more attributes, the purchasing strategy and the manufacturing strategy, then receiving a request to change the one or more search attributes.

9. The method of claim 4 further comprising if no commodity records from the commodity database and the blanket database satisfy the one the one or more attributes, the purchasing strategy and the manufacturing strategy, then receiving a request to create a new requisition.

10. The method of claim 9 further comprising creating a new requisition.

11. The method of claim 1 wherein the one or more attributes are provided by a requisitioner.

12. The method of claim 1 wherein the purchasing and manufacturing strategies are provided by a buyer organization.

13. The method of claim 12 wherein the commodity database is provided by the buyer organization.

14. A computer-implemented system for performing searching for products and services, the system comprising at least one server computer for communicating with at least one client computer, the at least one server computer being configured to:
receive a commodity database, the commodity database including one or more commodity records, each commodity record including supplier name, a description for a commodity, a commodity code and an inventory level for the commodity;
receive one or more search attributes, a purchasing strategy, and a manufacturing strategy, the purchasing strategy identifying one or more preferred suppliers based on the commodity code in each commodity record, the manufacturing strategy based on a target inventory level for a commodity described in at least one of the commodity records; and
search the commodity database to obtain one or more located commodity records that satisfy the one the one or more attributes, the purchasing strategy and the manufacturing strategy.

15. The system of claim 14 wherein the at least one buyer computer is further configured to receive a desired commodity record from the one or more located commodity records.

16. The system of claim 14 wherein the at least one server computer is further configured to search a blanket database to obtain one or more located commodity records that satisfy the one the one or more attributes, the purchasing strategy and the manufacturing strategy, the blanket database including one or more commodity records, each commodity record including supplier name and a description for a commodity.

17. The system of claim 16 wherein the at least one server computer is further configured to receive a desired commodity record from the one or more located commodity records from either the commodity database or the blanket database.

18. The system of claim 15 wherein the at least one server computer is further configured to transmit the desired commodity record in an electronic form.

19. The system of claim 18 wherein the electronic form is selected from the group consisting of a requisition, a shopping cart item and a request for quotation.

20. The system of claim 18 wherein the at least one server computer is further configured to cause display of the one or more located commodity records.

21. The system of claim 17 wherein the at least one server computer is further configured if no commodity records from the commodity database and the blanket database satisfy the one the one or more attributes, the purchasing strategy and the manufacturing strategy, then receive a request to change the one or more search attributes.

22. The system of claim 17 wherein the at least one server computer is further configured if no commodity records from the commodity database and the blanket database satisfy the one the one or more attributes, the purchasing strategy and the manufacturing strategy, then receive a request to create a new requisition.

23. The system of claim 22 wherein the at least one server computer is further configured to create a new requisition.

24. The system of claim 14 wherein the one or more attributes are provided by a requisitioner.

25. The system of claim 14 wherein the purchasing and manufacturing strategies are provided by a buyer organization.

26. The system of claim 25 wherein the inventory item database is provided by the buyer organization.

27. A computer-implemented system for performing searching for products and services, the system comprising at least one client computer for communicating with at least one server computer, the at least one client computer being configured to:
transmit a commodity database, the commodity database including one or more commodity records, each commodity record including supplier name, a description for a commodity, a commodity code and an inventory level for the commodity;
transmit one or more search attributes, a purchasing strategy, and a manufacturing strategy, the purchasing strategy identifying one or more preferred suppliers based on the commodity code in each commodity record, the manufacturing strategy based on a target inventory level for a commodity described in at least one of the commodity records; and
search the commodity database to obtain one or more located commodity records that satisfy the one the one or more attributes, the purchasing strategy and the manufacturing strategy.

28. A program for controlling a computer of a server for performing searching for products and services, the program comprising:
instructions for receiving a commodity database, the commodity database including one or more commodity records, each commodity record including supplier name, a description for a commodity, a commodity code and an inventory level for the commodity;
instructions for receiving one or more search attributes, a purchasing strategy, and a manufacturing strategy, the purchasing strategy identifying one or more preferred suppliers based on the commodity code in each commodity record, the manufacturing strategy based on a target inventory level for a commodity described in at least one of the commodity records; and
instructions for searching the commodity database to obtain one or more located commodity records that satisfy the one the one or more attributes, the purchasing strategy and the manufacturing strategy.

29. The program of claim 28 wherein the one or more attributes are provided by a requisitioner.

30. The program of claim 28 wherein the purchasing and manufacturing strategies are provided by a buyer organization.

31. The program of claim 30 wherein the inventory item database is provided by the buyer organization.
